(19) United States
(12) Patent Application Publication
(10) Pub. No.: US 2014/0177646 A1
(43) Pub. Date: Jun. 26, 2014

(54) NETWORK TERMINAL, COMMUNICATION METHOD, AND PROGRAM

(71) Applicant: PANASONIC CORPORATION, Osaka (JP)

(72) Inventors: Ken-ichi SHIBATA, Osaka (JP); Hiroki SHINOHARA, Kyoto (JP); Koichiro YAMAGUCHI, Osaka (JP)

(73) Assignee: PANASONIC CORPORATION, Osaka (JP)

(21) Appl. No.: 14/188,262

(22) Filed: Feb. 24, 2014

Related U.S. Application Data
(63) Continuation of application No. PCT/JP2013/000958, filed on Feb. 20, 2013.

(30) Foreign Application Priority Data
Oct. 30, 2012 (JP) 2012-238654

(51) Int. Cl. H04L 5/00

(52) U.S. Cl. CPC H04L 5/0092
USPC 370/458

(57) ABSTRACT

A network terminal including a communication unit for communicating with a device with which the network terminal communicates through a communication path, and a control unit for causing the communication unit, by controlling the communication unit, to transmit to the device a communication packet for maintaining the communication path at a transmission timing in every predetermined interval, wherein by controlling the communication unit, the control unit further causes the communication unit to transmit, if a terminal state of the network terminal is changed, to the device an information packet obtained by including terminal state information indicative of the terminal state in the communication packet, through the communication path even at a time different from the transmission timing.

### CROSS REFERENCE TO RELATED APPLICATIONS

This is a continuation application of PCT International Application No. PCT/JP2013/000958 filed on Feb. 20, 2013, designating the United States of America, which is based on and claims priority of Japanese Patent Application No. 2012-238654 filed on Oct. 30, 2012. The entire disclosures of the above-identified applications, including the specifications, drawings and claims are incorporated herein by reference in their entirety.

### FIELD

The present disclosure relates to a network terminal, a communication method, and a program.

### BACKGROUND

Japanese Unexamined Patent Application Publication No. 2004-120547 (PTL 1) discloses a communication system in network environment in which a LAN and the Internet are in connection, where a server on the Internet can connect to a terminal on the LAN at any time. A device included in the communication system periodically transmits a communication packet to the server. This allows the server to communicate with the terminal beyond a network address translation (NAT) device or network address port translation (NAPT) device.

### SUMMARY

The present disclosure provides a network terminal which allows a server to acquire data corresponding to a terminal state of the network terminal through a small amount of communications.

A network terminal according to an aspect of the present disclosure includes: a communication unit configured to communicate with a device with which the network terminal communicates through a communication path; and a control unit configured to cause the communication unit, by controlling the communication unit, to transmit to the device a communication packet for maintaining the communication path at a transmission timing in every predetermined interval, wherein by controlling the communication unit, the control unit further causes the communication unit to transmit an information packet to the device through the communication path even at a time different from the transmission timing, if a terminal state of the network terminal is changed, and determine a new transmission timing for the communication packet in each predetermined interval, starting from a moment at which the communication unit has transmitted the information packet, the information packet being a communication packet obtained by storing terminal state information indicative of the terminal state into the communication packet for maintaining the communication path. Moreover, the network terminal according to an aspect of the present disclosure includes: a communication unit configured to communicate with a device with which the network terminal communicates through a communication path; and a control unit configured to cause the communication unit, by controlling the communication unit, to transmit to the device a communication packet for maintaining the communication path at a transmission timing in every predetermined interval, wherein by controlling the communication unit, the control unit further causes the communication unit to transmit an information packet to the device through the communication path even at a time different from the transmission timing, if a terminal state of the network terminal is changed, the information packet being a communication packet obtained by storing terminal state information indicative of the terminal state.

### BRIEF DESCRIPTION OF DRAWINGS

These and other objects, advantages and features of the disclosure will become apparent from the following description thereof taken in conjunction with the accompanying drawings that illustrate a specific embodiment of the present disclosure

[FIG. 1]

FIG. 1 is a diagram of a network which includes a network terminal according to a non-limiting embodiment 1.

[FIG. 2]

FIG. 2 is a block diagram of a configuration of the network terminal according to the embodiment 1.

[FIG. 3]

FIG. 3 is a conceptual diagram showing a structure of a communication packet according to the embodiment 1.

[FIG. 4]

FIG. 4 is a flowchart illustrating a communication packet transmission process periodically performed by the network terminal according to the embodiment 1.

[FIG. 5]

FIG. 5 is a flowchart illustrating a packet transmission process upon change of a terminal state of the network terminal according to the embodiment 1.

[FIG. 6]

FIG. 6 is a flowchart illustrating an update process of a terminal state in a server according to the embodiment 1.

[FIG. 7]

FIG. 7 is a sequence diagram of communications between the network terminal and the server according to the embodiment 1.

[FIG. 8]

FIG. 8 is a diagram of a network which includes a network terminal according to a non-limiting embodiment 2.

[FIG. 9]

FIG. 9 is a block diagram of a configuration of the network terminal according to the embodiment 2.

[FIG. 10]

FIG. 10 is a flowchart illustrating a packet transmission process upon change of a terminal state of the network terminal according to the embodiment 2.

[FIG. 11]

FIG. 11 is a flowchart illustrating a packet transmission process upon release of the network terminal according to the embodiment 2 from holding packet transmission.

[FIG. 12]

FIG. 12 is a sequence diagram of communications between the network terminal and a server according to the embodiment 2.

[FIG. 13]

FIG. 13 is a conceptual diagram of a structure of terminal state information according to the embodiment 2.

[FIG. 14]

FIG. 14 is a diagram showing a packet format of a communication packet according to the embodiment 2.

[FIG. 15]

FIG. 15 is a block diagram of a configuration of a network terminal according to a non-limiting embodiment 3.

[FIG. 16]

FIG. 16 is a flowchart illustrating a packet transmission process upon change of a terminal state of the network terminal according to the embodiment 3.

[FIG. 17]

FIG. 17 is a flowchart illustrating a packet transmission process upon unblocking of packet transmission performed by the network terminal according to the embodiment 3.

[FIG. 18]

FIG. 18 is a sequence diagram of communications between the network terminal and a server according to the embodiment 3.

[FIG. 19]

FIG. 19 is a block diagram of another configuration of the network terminal according to the embodiments 1 to 3.

### DESCRIPTION OF EMBODIMENTS

Hereinafter, non-limiting embodiments will be described in detail with reference to the accompanying drawings. However, unnecessarily detailed description may be omitted. For example, detailed description of well-known matters or description previously set forth with respect to components that are substantially the same may be omitted. This is to avoid unnecessary redundancy in the description below and for facilitating an understanding by those skilled in the art.

It should be noted that the inventors provide the accompanying drawings and the description below for a thorough understanding of the present disclosure by those skilled in the art, and the accompanying drawings and the description are not intended to be limiting the subject matter recited in the claims appended hereto.

First, a problem to be solved by the present disclosure will be described in detail.

For communications between devices connected to the Internet, a global IP address globally assigned uniquely to each device is used. On the other hand, in a local area network (LAN) in which devices are not directly connected to the Internet, a recent trend is to use a private IP address which is unique to each device only in LAN. However, a device having a private IP address in LAN and a device having a global IP address on the Internet have different addressing schemes, and thus unable to directly communicate with each other. Hence, a router relaying between the LAN and the Internet intertranslates between global IP addresses and private IP addresses using a network address translation (NAT) function or a network address port translation (NAPT) function, thereby enabling communications between terminals in LAN and devices on the Internet.

Hereinafter, operation of the NAPT function will be described. After receiving a communication packet destined for a device on the Internet from a terminal in a LAN, a router having the NAPT function creates a translation table (hereinafter, referred to as a “NAT table”) which includes a set of: a pair of a private IP address and a port number which correspond to the terminal in the LAN; and a pair of a global IP address and a port number which correspond to the device on the Internet. Moreover, after receiving a communication packet from a device on the Internet, the router refers to a pair of a global IP address and a port number of a destination in the communication packet and determines whether the NAT table includes an entry that matches the pair of global IP address and port number of the destination. Here, if the entry exists, the router forwards the communication packet to a terminal in LAN that has a private IP address set with the pair of global IP address and port number of the destination. If the entry does not exist, on the other hand, the router discards the communication packet.

In general, a NAT table is stored in a memory of a router which has the NAPT function. Since memory capacity is limited, a NAT entry left unused is deleted over time. Therefore, if a device on the Internet does not return a response for a while since the device has received a communication packet from a terminal in a LAN, an entry corresponding to the communication packet is deleted from the NAT table. As a result, the device on the Internet may not be able to connect to the terminal in the LAN.

PTL 1 discloses a communication system in network environment in which a LAN and the Internet are in connection, where a server on the Internet can connect to a terminal on the LAN at any time. A device included in the communication system periodically transmits a communication packet to the server. This allows the server to communicate with the NAT device or NAPT device. Utilizing this communications, the server can send data to a terminal, and another terminal in a LAN can operate the terminal, for example.

The present disclosure provides a network terminal which allows a server to acquire data corresponding to a terminal state of the network terminal through a small amount of communications.

The network terminal according to the present disclosure includes: a communication unit configured to communicate with a device with which the network terminal communicates through a communication path; and a control unit configured to cause the communication unit, by controlling the communication unit, to transmit to the device a communication packet for maintaining the communication path at a transmission timing in every predetermined interval, wherein by controlling the communication unit, the control unit further causes the communication unit to transmit an information packet to the device through the communication path even at a time different from the transmission timing, if a terminal state of the network terminal is changed, and determine a new transmission timing for the communication packet in each predetermined interval, starting from a moment at which the communication unit has transmitted the information packet, the information packet being a communication packet obtained by storing terminal state information indicative of the terminal state into the communication packet for maintaining the communication path. Moreover, the network terminal according to the present disclosure includes: a communication unit configured to communicate with a device with which the network terminal communicates through a communication path; and a control unit configured to cause the communication unit, by controlling the communication unit, to transmit to the device a communication packet for maintaining the communication path at a transmission timing in every predetermined interval, wherein by controlling the communication unit, the control unit further causes the communication unit to transmit an information packet to the device through the communication path even at a time different from the transmission timing, if a terminal state of the network terminal is changed, the information packet being a communication packet obtained by storing terminal state information indicative of the terminal state.

According to the above configuration, the network terminal periodically transmits (periodic transmission) a communication packet that is capable of maintaining a communication path, and also transmits, if the terminal state of the network terminal is changed, an information packet that is capable of maintaining the communication path and also notifying the terminal state of the network terminal to the device with which the network terminal communicates. If the communication packet or the information packet passes through the communication path, the communication path is maintained for a predetermined time period thereafter. By setting the predetermined time period so that the next communication packet or the information packet can pass through the communication path within the predetermined time period, the communication path is maintained over an extended time period longer than the predetermined time period. If there is no change in terminal state of the network terminal, the communication path is maintained by a communication packet that is periodically transmitted. On the other hand, if the terminal state of the network terminal is changed, the communication path is maintained and the change in terminal state of the network terminal is notified to the device with which the network terminal communicates, using the information packet that is capable of maintaining the communication path in addition to notifying the terminal state of the network terminal. Since immediately after the terminal state of the network terminal is changed, the network terminal notifies the change in terminal state of the network terminal to the device with which the network terminal communicates, the network terminal can acquire, from the device with which the network terminal communicates, data in accordance with the terminal state of the network terminal.

According to the conventional technology, if the terminal state of a network terminal is changed, a communication packet is transmitted once a time interval for periodic transmission has elapsed since the time at which the previous communication packet has been transmitted. In contrast, according to the network terminal of the present disclosure, if the terminal state of the network terminal is changed, there is no need to transmit the next communication packet until the time interval for periodic transmission elapses since the time at which the information packet has been transmitted. Thus, the number of communication packets to be transmitted can be reduced as compared to the conventional technology. Thus, the network terminal can acquire data in accordance with the terminal state through a small amount of communications.

Moreover, for example, if the communication unit transmits the information packet, the control unit determines a new transmission timing for the communication packet in each predetermined interval, starting from a time at which the communication unit has transmitted the information packet.

According to the above configuration, after transmitting an information packet, the network terminal transmits a communication packet once a time interval for periodic transmission has elapsed since the time at which the information packet has been transmitted. According to the conventional technology, the communication packet needs to be transmitted prior to this time point. Thus, the network terminal can further reduce the amount of communications.

Moreover, for example, by controlling the communication unit, the control unit causes the communication unit to transmit the information packet which includes the terminal state information indicative of the terminal state during a hold time period if the terminal state is changed during the hold time period until a predetermined hold time elapses since the communication unit has transmitted the information packet, after the hold time period.

According to the above configuration, the network terminal can transmit a change in terminal state of the network terminal during the hold time period in a communication packet (information packet) after the hold time period. This has an advantageous effect of reducing a number of transmissions of communication packets, in particular, when the terminal state of the network terminal is changed a large number of times in a short time. Thus, the network terminal can further reduce the amount of communications.

Moreover, for example, by controlling the communication unit, the control unit causes the communication unit to transmit, after the hold time period, the information packet which includes the terminal state information indicative of a history of the terminal state during the hold time period.

According to the above configuration, the network terminal can transmit the history of terminal state change of the network terminal during the hold time period in a communication packet (information packet) after the hold time period. In this way, the device with which the network terminal communicates can acquire information on the terminal state change in more detail.

Moreover, for example, the control unit inhibits the communication unit from transmitting the information packet if the terminal state after the hold time period is unchanged from the terminal state before the hold time period

According to the above configuration, the network terminal does not transmit a communication packet (an information packet) after the hold time period. Thus, the network terminal can further reduce the amount of communications.

Moreover, for example, the control unit controls the communication unit, using as the hold time a hold time that is specified by the device.

According to the above configuration, the device with which the network terminal communicates can initiatively specify the hold time for the network terminal, thereby further reducing the amount of communication packets over a network.

Moreover, for example, the control unit inhibits the communication unit from transmitting the information packet during an inhibited time period until a predetermined inhibited time elapses since the terminal state is changed, and, by controlling the communication unit, causes the communication unit to transmit, after the inhibited time period, the information packet which includes the terminal state information indicative of the terminal state during the inhibited time period.

According to the above configuration, the network terminal can transmit a change in terminal state of the network terminal during the inhibited time period in a communication packet (information packet) after the inhibited time period. This has an advantageous effect of reducing a number of transmissions of communication packets, in particular, when the terminal state of the network terminal is changed a large number of times in a short time. Besides, the communication packet (information packet) is not transmitted immediately after the terminal state is changed. Consequently, this has more advantageous effect of reducing a number of transmissions of communication packets. Thus, the network terminal can further reduce the amount of communications.

Moreover, for example, by controlling the communication unit, the control unit causes the communication unit to transmit, after the inhibited time period, the information packet which includes the terminal state information indicative of a history of the terminal state during the inhibited time period.

According to the above configuration, the network terminal can transmit the history of terminal state change of the network terminal during the inhibited time period in a communication packet (information packet) after the inhibited time period. In this way, the device with which the network terminal communicates can acquire information on the terminal state change in more detail.

Moreover, for example, the control unit inhibits the communication unit from transmitting the information packet if the terminal state after the inhibited time period is unchanged from the terminal state before the inhibited time period.

According to the above configuration, the network terminal does not transmit a communication packet (an information packet) after the inhibited time period if the terminal state of the network terminal after the inhibited time period is unchanged from the terminal state of the network terminal before the inhibited time period. Thus, the network terminal can further reduce the amount of communications.

Moreover, for example, the control unit controls the communication unit, using as the inhibited time an inhibited time that is specified by the device.

According to the above configuration, the device with which the network terminal communicates can initiatively specify the inhibited time for the network terminal, thereby further reducing the amount of communication packets over the network.

Moreover, for example, the network terminal further includes a broadcast receipt unit configured to receive broadcast of a broadcast channel, wherein the communication unit transmits, as the terminal state information, the information packet which includes information indicative of the broadcast channel received by the broadcast receipt unit.

According to the above configuration, the network terminal can transmit, as the terminal state information, broadcast channel information, which is received by the network terminal, to the device with which the network terminal communicates.

Moreover, for example, the communication unit further receives advertising content in accordance with the terminal state, transmitted by the device, the network terminal further including a display unit configured to display the advertising content.

According to the above configuration, the network terminal can receive and display advertising content specified in accordance with the terminal state of the network terminal by the server.

Moreover, for example, the network terminal further includes a positional information acquisition unit configured to acquire positional information of the network terminal, wherein the communication unit transmits the information packet which includes the positional information as the terminal state information, and receives the advertising content in accordance with the positional information, transmitted by the device.

According to the above configuration, the network terminal can receive and display advertising content specified in accordance with positional information of the network terminal by the server

Moreover, for example, the network terminal further includes a sensor for acquiring attribute information indicative of an attribute of a person near the network terminal or environmental information indicative of environment surrounding the network terminal, wherein the communication unit transmits the information packet which includes at least one of the attribute information and the environmental information as the terminal state information.

According to the above configuration, the network terminal can receive and display advertising content specified in accordance with conditions surrounding the network terminal or conditions of people around the network terminal by the server.

Moreover, for example, a router having a network address translation (NAT) function is disposed on the communication path, and the communication unit maintains a NAT table in the router by transmitting the communication packet or the information packet to the device through the router to maintain the communication path.

According to the above configuration, the network terminal can maintain the communication path between the network terminal and the device by maintaining a NAT table in the router on the communication path.

### Embodiment 1

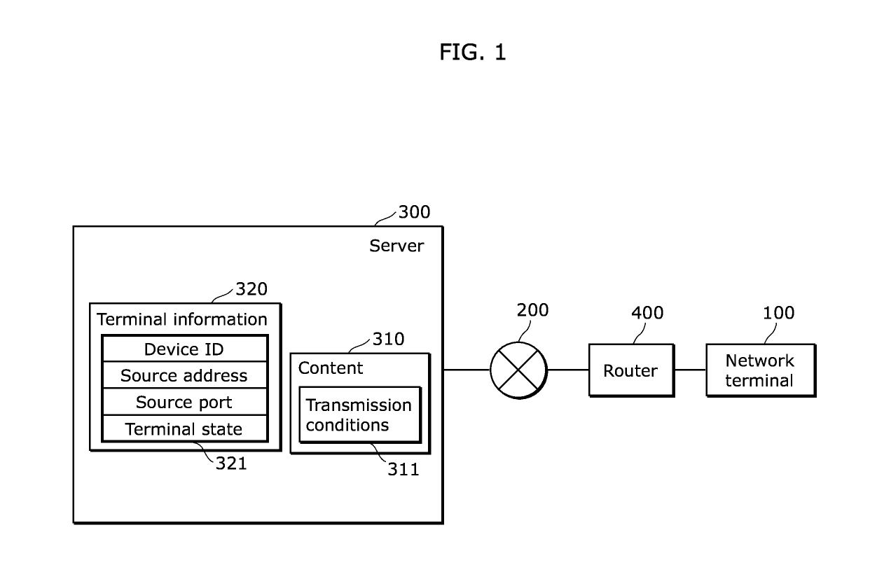

Hereinafter, an embodiment 1 will be described, with reference to FIGS. 1 through 7.

[1-1. Configuration]

[1-1-1. Network Connection Configuration]

FIG. 1 is a diagram of a network which includes a network terminal 100 according to the embodiment 1. FIG. 1 shows a state where the network terminal 100 according to the present embodiment is connected to a network.

The network terminal 100 is a terminal which communicates with a server 300. The network terminal 100 is connectable to the server 300 via a router 400 and an Internet 200. The network terminal 100 has a private IP address.

The server 300 stores content 310 (such as messages or advertising data) to be distributed to the network terminal 100. Transmission conditions 311 are set to the content 310. The transmission conditions 311 is represented by, for example, “Transmission time=9/26 12:00, Viewing channel=BS909”, meaning that “a program on channel 909 of BS will be transmitted at noon, September, 26 to a terminal being used by a user.” The server 300 checks the transmission conditions 311 of the content 310 when, for example, the content 310 is registered with the server 300, and then provides the content 310 to the network terminal 100 that has the terminal state matching the transmission conditions 311. Content without transmission conditions may be provided to terminals, irrespective of terminal states. The server 300 has a global IP address. It should be noted that the server 300 corresponds to a device with which the network terminal 100 communicates.

Moreover, after receiving a communication packet from the network terminal 100, the server 300 stores, as terminal information 320, a set of a device ID, a source address, and a source port which are included in the communication packet. Here, the device ID is an identifier which allows the server 300 to uniquely identify the network terminal 100. The source address and the source port are a global IP address and a port number, respectively, which are allocated to the communication packet by the router 400 using the NAT function or the NAPT function. It should be noted that if the communication packet includes a terminal state, the terminal state is also stored linked with the device ID, as part of the terminal information 320. It should be noted that the router 400 corresponds to a communication path.

The router 400 is connected to the network terminal 100 and the Internet 200. The router 400 transmits, to the Internet 200, the communication packet transmitted by the network terminal 100, and transmits, to the network terminal 100, a communication packet which is destined for the network terminal 100 and received from the Internet 200. The router 400 has the NAT function or the NAPT function, and stores in a NAT table an entry associated with a private IP address used by the network terminal 100 and a global IP address used by the Internet 200. Then, after forwarding the communication packet, the router 400 updates an entry, in the NAT table, that corresponds to the communication packet. On the other hand, an entry which has not been updated for a predetermined time period is deleted from the NAT table. Moreover, the router 400 intertranslates between the private IP address and the global IP address, using the entry.

The Internet 200 is a network through which the communication packet which is communicated between the router 400 and the server 300 is forwarded. A global IP addressing scheme is employed on the Internet 200.

[1-1-2. Configuration of Network Terminal]

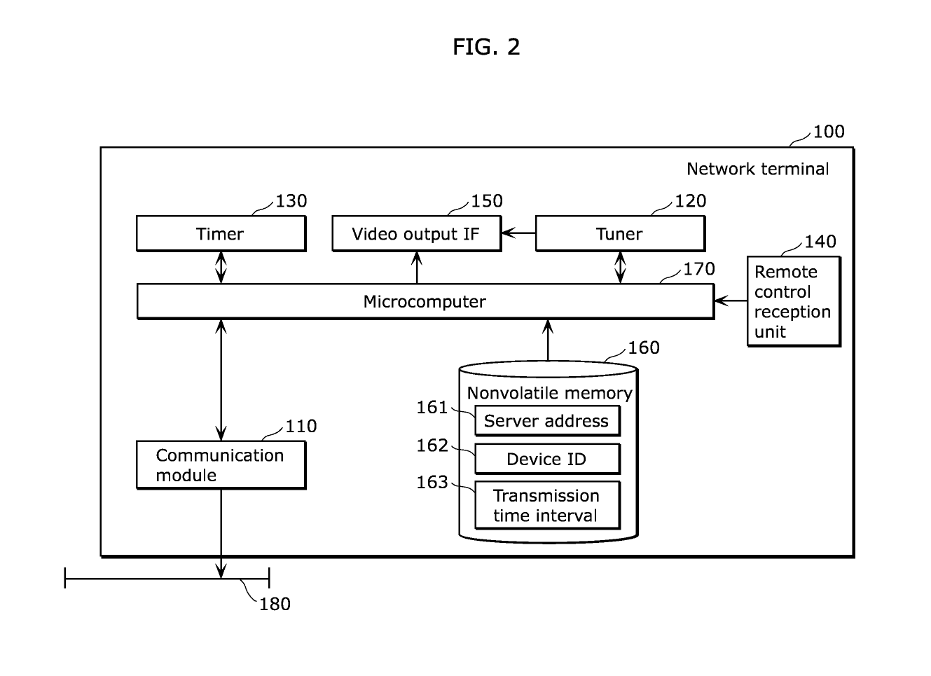

FIG. 2 is a block diagram of a configuration of the network terminal 100 according to the present embodiment. The network terminal 100 includes a communication module 110, a tuner 120, a timer 130, a remote control reception unit 140, a video output IF 150, a nonvolatile memory 160, and a microcomputer 170.

The communication module 110 is connected to a network 180 such as LAN, and communicates with the device through the network 180. A destination and content of communications by the communication module 110 are specified by the microcomputer 170.

The tuner 120 receives a broadcast signal from television broadcasting or the like, converts the broadcast signal into a format that can be output by the video output IF 150, and outputs a resultant broadcast signal to the video output IF 150. A channel to be received by the tuner 120 is specified by the microcomputer 170. The tuner 120 corresponds to a broadcast receipt unit.

The timer 130 is implemented in software or hardware. The timer 130 generates an interrupt to the microcomputer 170 at a set time. The microcomputer 170 sets the timer 130.

The remote control reception unit 140 receives a signal of operation by a user on a remote controller. The remote control reception unit 140 notifies the microcomputer 170 of a key depressed by the user on the remote controller.

The nonvolatile memory 160 is a memory storing a server address 161, a device ID 162, and a transmission interval 163. The server address 161 is an identifier uniquely identifying the server, examples of which include a domain name and a port number of the server 300. The global IP address of the server 300 may be used instead of domain name. The device ID 162 is an identifier uniquely identifying the network terminal 100. The transmission interval 163 represents transmission intervals for a communication packet which is periodically transmitted to the server to maintain the NAT table in the router 400. If the transmission interval 163 is shorter than a time period for which the router 400 maintains the NAT table, the NAT table in the router 400 can be maintained longer than the transmission interval for the communication packet.

The microcomputer 170 controls the entirety of the network terminal 100, according to a computer program described in software or firmware. If the microcomputer 170 is notified by the remote control reception unit 140 of a channel key depressed on the remote controller, the microcomputer 170 causes the tuner 120, by controlling the tuner 120, to select a channel designated by the channel key. If the communication module 110 is connected to the network 180, the microcomputer 170 reads the server address 161 and the device ID 162 from the nonvolatile memory 160 and generates a communication packet 190 to be transmitted to the server 300. Then, the microcomputer 170 requests the communication module 110 to transmit the communication packet 190. The generation and the transmit request for the communication packet 190 are periodically performed in the transmission interval 163. The microcomputer 170 receives content (for example, advertising content) from the server 300 via the communication module 110, processes or converts the received content according to need, and then outputs the content to the video output IF 150.

The video output IF 150 outputs, as a video, the broadcast signal output by the tuner 120. If the microcomputer 170 outputs content, the video output IF 150 outputs the content as a video.

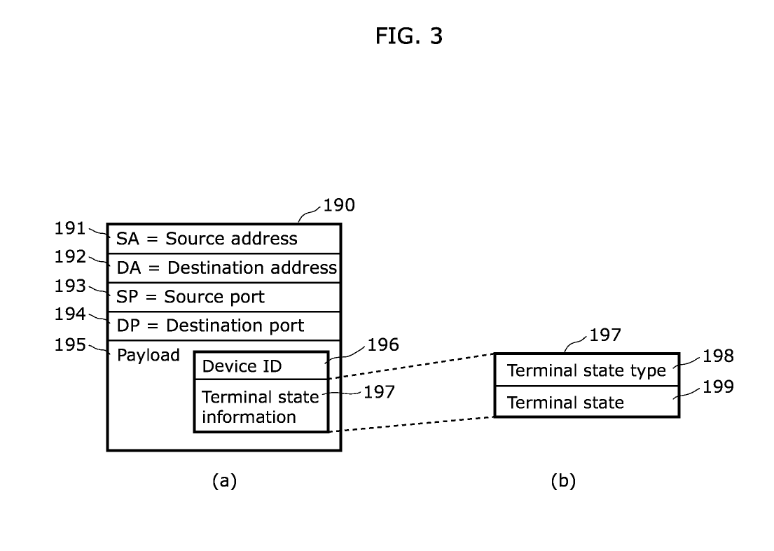

FIG. 3 is a conceptual diagram of a configuration of the communication packet 190 according to the present embodiment. As shown in (a) of FIG. 3, the communication packet 190 includes a source address 191, a destination address 192, a source port 193, a destination port 194, and payload 195. The payload 195 includes a device ID 196 and terminal state information 197.

As shown in (b) of FIG. 3, the terminal state information 197 includes a terminal state type 198 and a terminal state 199. The terminal state type 198 is any information indicating a terminal state, including, for example, a value indicating a channel being viewed, attribute information on a person obtained as a result of a camera recognizing the person, or environmental information obtained as a result of a sensor acquiring environment surrounding the network terminal 100. Hereinafter, an example will be described where a value indicating a channel being viewed is used as the terminal state type 198. It is assumed that a way in which the network terminal 100 describes the terminal state information 197 and a way in which the server 300 interprets the terminal state information 197 are agreed between the network terminal 100 and the server 300. It should be noted that the terminal state information 197 may not include any information. The terminal state information 197 corresponds to “terminal state information indicating a terminal state of the network terminal.”

[1-2. Operation]

Operations of the network terminal 100 and the server 300 configured as described above are described below. The network terminal 100 periodically performs a communication packet transmission process, and if the terminal state is changed, the network terminal 100 performs the communication packet transmission process. The server 300 performs a terminal state update process upon reception of a communication packet. Hereinafter, each operation will be described in detail.

[1-2-1. Packet Transmission Process Periodically Performed by Network Terminal]

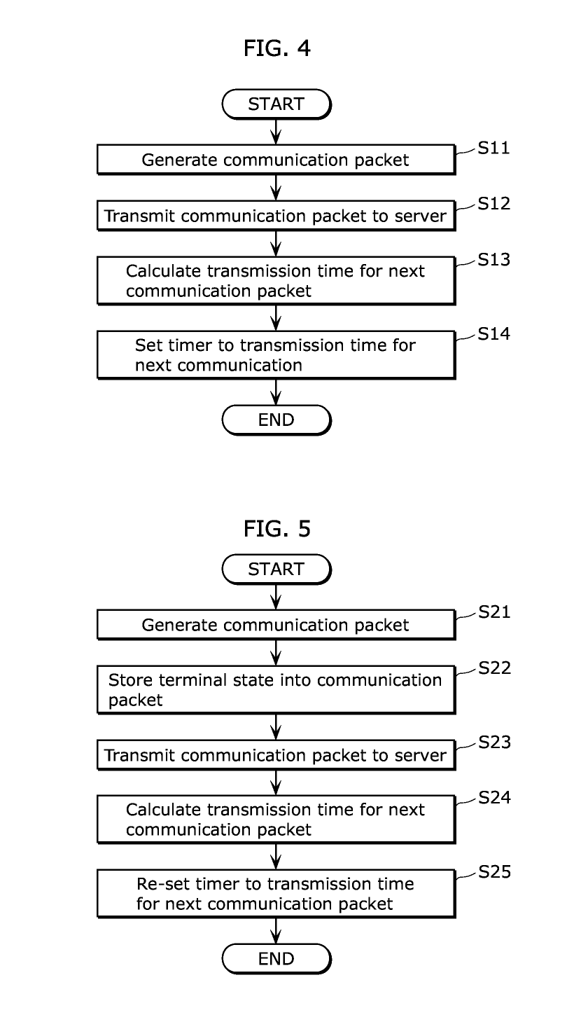

FIG. 4 is a flowchart illustrating the communication packet transmission process periodically performed by the network terminal 100 according to the present embodiment.

If the microcomputer 170 receives an interrupt for packet transmission request from the timer 130, the microcomputer 170 starts the processing illustrated in the flowchart of FIG. 4.

First, the microcomputer 170 generates a communication packet (step S11).

Next, the microcomputer 170 requests the communication module 110 to transmit the communication packet generated in step S11. Upon receipt of the request from the microcomputer 170, the communication module 110 transmits the communication packet to the server 300 (step S12).

Next, the microcomputer 170 acquires the transmission interval 163 from the nonvolatile memory 160 and adds the transmission interval 163 to the current time, thereby calculating a transmission time for the next communication packet (step S13).

Next, the microcomputer 170 sets the timer 130 to the transmission time for the next communication packet so as to receive an interrupt for packet transmission request when the transmission time calculated in step S13 arrives (step S14).

It should be noted that the microcomputer 170 may store the currently viewed channel into the communication packet generated in step S11. In this way, the server 300 can periodically verify whether the terminal state stored in the server 300 and the terminal state of the network terminal 100 are identical.

[1-2-2. Packet Transmission Process upon Change of Terminal State of Network Terminal]

FIG. 5 is a flowchart illustrating a process of transmitting a communication packet (information packet) upon change of the terminal state of the network terminal 100 according to the present embodiment.

First, if the tuner 120 successfully selects a channel (i.e., if the terminal state is changed), the microcomputer 170 generates a communication packet (step S21).

Next, the microcomputer 170 stores information indicating the currently viewed channel into the terminal state information 197 of the communication packet (step S22).

Next, the microcomputer 170 transmits the communication packet to the server 300 by a process similar to step S12 (step S23). The communication packet transmitted here is a communication packet (information packet) which includes the terminal state information 197.

Next, the microcomputer 170 calculates a transmission time for the next communication packet by a process similar to step S13 (step S24).

Next, the microcomputer 170 re-sets the timer 130 to the transmission time for the next communication packet so as to receive an interrupt for packet transmission request when the transmission time calculated in step S24 arrives (step S25). At the end of step S24, the transmission time in step S14 is loaded into the timer 130. Thus, the process of step S25 can also be expressed as the microcomputer 170 re-setting the timer 130 to the transmission time in step S25 and thereby correcting the transmission time.

Thereafter, the network terminal 100 ends the processing.

[1-2-3. Update Process of Terminal State in Server]

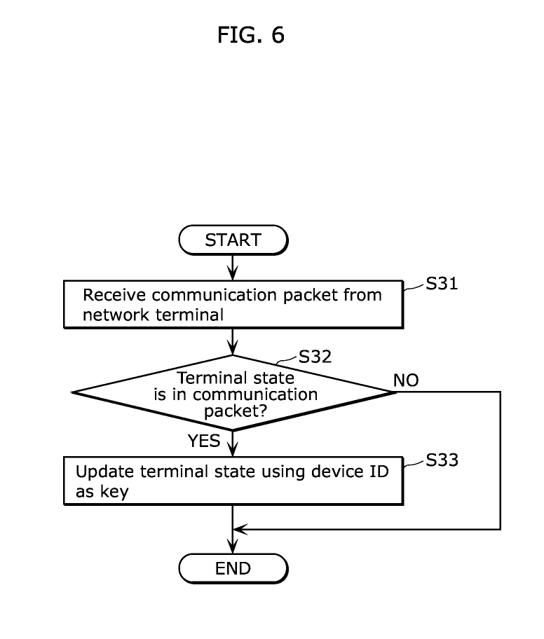

FIG. 6 is a flowchart illustrating an update process of a terminal state in the server 300 according to the present embodiment.

First, the server 300 receives the communication packet 190 from the network terminal 100 (step S31).

Next, the server 300 determines whether the terminal state 199 is stored in the communication packet 190 (step S32).

In step S32, if the server 300 determines that the terminal state 199 is stored in the communication packet 190 (YES in step S32), the server 300 updates the terminal state in the terminal information 320, using the device ID 196 as a key (step S33).

On the other hand, in step S32, if the server 300 determines that the terminal state 199 is not stored in the communication packet 190 (NO in step S32), the server 300 does not update the terminal state in the terminal information 320.

[1-2-4. Sequence between Network Terminal and Server]

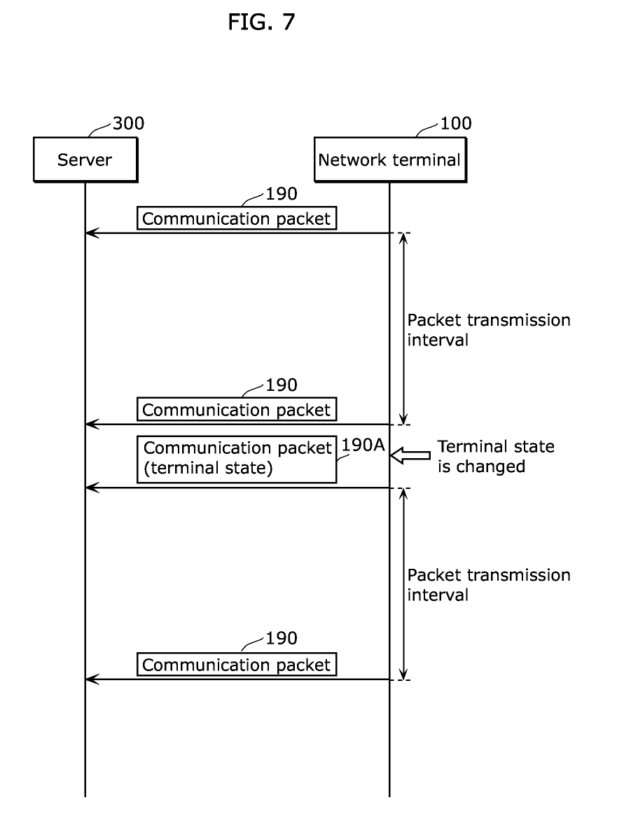

FIG. 7 is a sequence diagram showing communications between the network terminal 100 and the server 300 according to the present embodiment. In FIG. 7, transmission timings for communication packets which are transmitted and received between the network terminal 100 and the server 300 are shown.

The network terminal 100 periodically transmits a communication packet 190 in the transmission interval 163 stored in the nonvolatile memory 160. Moreover, irrespective of elapsed time since the previous transmission, once the terminal state is changed the network terminal 100 immediately transmits a communication packet 190A which includes the terminal state. Thereafter, if the terminal state is not changed, the network terminal 100 periodically transmits the communication packet 190 in the transmission interval stored in the nonvolatile memory 160.

[1-3. Summary]

As described above, in the present embodiment, the network terminal 100 periodically performs the packet transmission process to maintain the NAT table, and once the terminal state is changed by selection of channel, the network terminal 100 immediately performs the process of transmitting a packet which includes the terminal state. After receiving the communication packet which includes the terminal state, the server 300 updates the terminal state stored in the server 300.

This allows the server 300 to be notified of a new terminal state in real time. Thus, the network terminal 100 is likely to obtain content in accordance with the terminal state, from the server 300.

In the present embodiment, the network terminal 100 may store the current terminal state in the communication packet even in the periodical packet transmission process.

This allows the server 300 to check whether the terminal state stored in the server 300 is correct. Thus, correction is made if the server 300 stores an incorrect terminal state, and the network terminal 100 is likely to obtain content in accordance with the terminal state, from the server 300.

As described above, according to the network terminal of the present embodiment, the network terminal periodically transmits (periodic transmission) a communication packet that is capable of maintaining a communication path, and also transmits, if the terminal state of the network terminal is changed, an information packet that is capable of maintaining the communication path and also notifying the terminal state of the network terminal to the device with which the network terminal communicates. If the communication packet or the information packet passes through the communication path, the communication path is maintained for a predetermined time period thereafter. By setting the predetermined time period so that the next communication packet or the information packet can pass through the communication path within the predetermined time period, the communication path is maintained over an extended time period longer than the predetermined time period. If there is no change in terminal state of the network terminal, the communication path is maintained by a communication packet that is periodically transmitted. On the other hand, if the terminal state of the network terminal is changed, the communication path is maintained and the change in terminal state of the network terminal is notified to the device with which the network terminal communicates, using the information packet that is capable of maintaining the communication path in addition to notifying the terminal state of the network terminal. Since immediately after the terminal state of the network terminal is changed, the network terminal notifies the change in terminal state of the network terminal to the device with which the network terminal communicates, the network terminal can acquire, from the device with which the network terminal communicates, data in accordance with the terminal state of the network terminal.

According to the conventional technology, if the terminal state of a network terminal is changed, a communication packet is transmitted once a time interval for periodic transmission has elapsed since the time at which the previous communication packet has been transmitted. In contrast, according to the network terminal of the present disclosure, if the terminal state of the network terminal is changed, there is no need to transmit the next communication packet until the time interval for periodic transmission elapses since the time at which the information packet has been transmitted. Thus, the number of communication packets to be transmitted can be reduced as compared to the conventional technology. Thus, the network terminal can acquire data in accordance with the terminal state through a small amount of communications.

Moreover, after transmitting an information packet, the network terminal transmits a communication packet once a time interval for periodic transmission has elapsed since the time at which the information packet has been transmitted. According to the conventional technology, the communication packet needs to be transmitted prior to this time point. Thus, the network terminal can further reduce the amount of communications.

Moreover, the network terminal can transmit, as the terminal state information, broadcast channel information, which is received by the network terminal, to the device with which the network terminal communicates.

Moreover, the network terminal can receive and display advertising content specified in accordance with the terminal state of the network terminal by the server.

Moreover, the network terminal can receive and display advertising content specified in accordance with positional information of the network terminal by the server.

Moreover, the network terminal can receive and display advertising content specified in accordance with conditions surrounding the network terminal or conditions of people around the network terminal by the server.

Moreover, the network terminal can maintain the communication path between the network terminal and the device by maintaining a NAT table in the router on the communication path.

### Embodiment 2

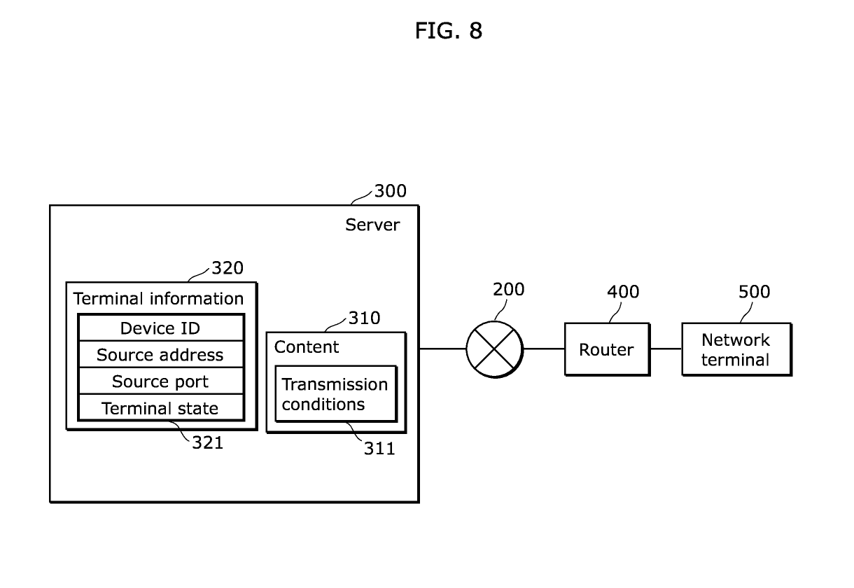

Hereinafter, an embodiment 2 will be described, with reference to FIGS. 8 to 14. The network terminal according to the present embodiment can reduce an amount of communications when the terminal state of the network terminal is frequently changed by employing a transmission hold time period. It should be noted that the same reference signs will be used to refer to the same components as those according to the embodiment 1, and detailed description may be omitted.

[2-1. Configuration]

[2-1-1. Network Connection Configuration]

FIG. 8 is a diagram of a network which includes a network terminal 500 according to the present embodiment. FIG. 8 shows the network terminal 500 according to the present embodiment connected to a network.

The network terminal 500 is connectable to the server 300 via a router 400 and an Internet 200.

[2-1-2. Configuration of Network Terminal]

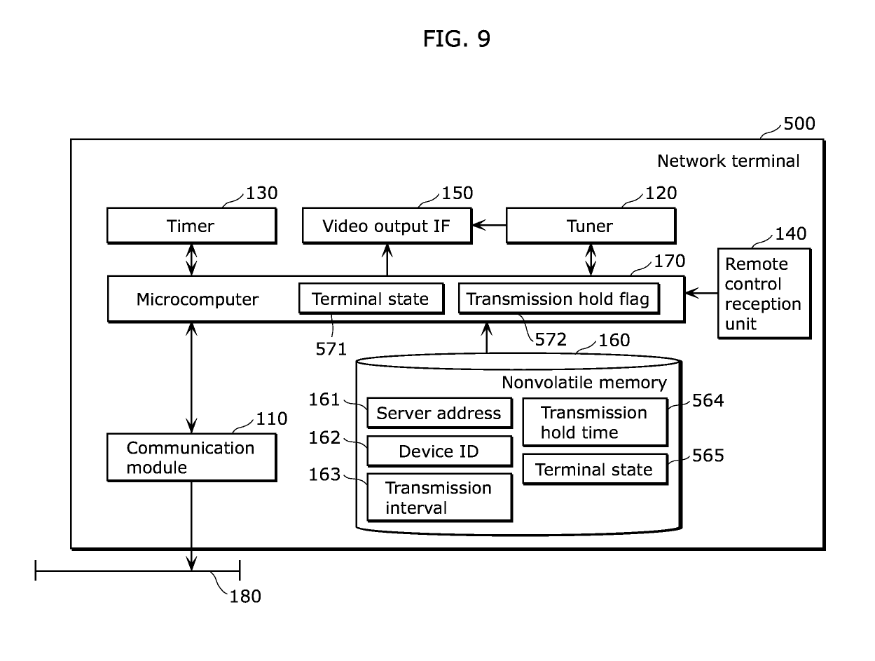

FIG. 9 is a block diagram of a configuration of the network terminal 500 according to the present embodiment. The network terminal 500 includes components similar to those of the network terminal 100 and, additionally, stores a transmission hold time 564 and a terminal state 565 in the nonvolatile memory 160.

The transmission hold time 564 is a time (the hold time period) after a communication packet is transmitted by the network terminal 500 upon change of the terminal state of the network terminal 500 and during which transmission of a subsequent communication packet is on hold. In other words, if the terminal state of the network terminal 500 is changed again immediately after the network terminal 500 transmits a communication packet upon change of the terminal state, another communication packet is not transmitted at that time because it is during the hold time. Suppose that a user is switching channels one after another looking for a program desired by the user (=during channel zapping), if a communication packet is transmitted each time channels are switched, the transmission processing by the network terminal 500 increases, causing a heavier load on the network terminal 500. Furthermore, the Internet 200 and the server 300 are also flooded with a large number of communication packets and loads are applied thereto. Hence, the transmission hold time 564 can reduce the load even in a state where the terminal state is highly frequently changed. It is assumed that the transmission hold time 564 is shorter than the time period for which the router 400 maintains the NAT table. It should be noted that the transmission hold time 564 may be a value previously set to the network terminal 500 or a value received from the server 300.

The terminal state 565 indicates information such as channels previously viewed at the network terminal 500. The terminal state 565 is created, updated, or deleted by the microcomputer 170, according to need.

The microcomputer 170 includes an internal memory. The microcomputer 170 stores a terminal state 571 and a transmission hold flag 572 in the internal memory, according to need. The terminal state 571 is information such as a channel currently viewed at the network terminal 500. The transmission hold flag 572 is a flag which is enabled when the microcomputer 170 is holding transmission of a communication packet.

[2-2. Operation]

Operations of the network terminal 500 and the server 300 configured as described above are described below. The network terminal 100 periodically performs a communication packet transmission process, and if the terminal state is changed, the network terminal 500 performs the communication packet transmission process. The communication packet transmission process periodically performed by the network terminal 500 is similar to that described in the embodiment 1. On the other hand, the network terminal 500 performs a packet transmission process upon change of the terminal state by a method different from the process disclosed in the embodiment 1, in consideration of the transmission hold time. Furthermore, the network terminal 500 performs a packet transmission process after the end of the transmission hold time. Hereinafter, details of the operation will be described.

[2-2-1. Packet Transmission Process upon Change of Terminal State of Network Terminal]

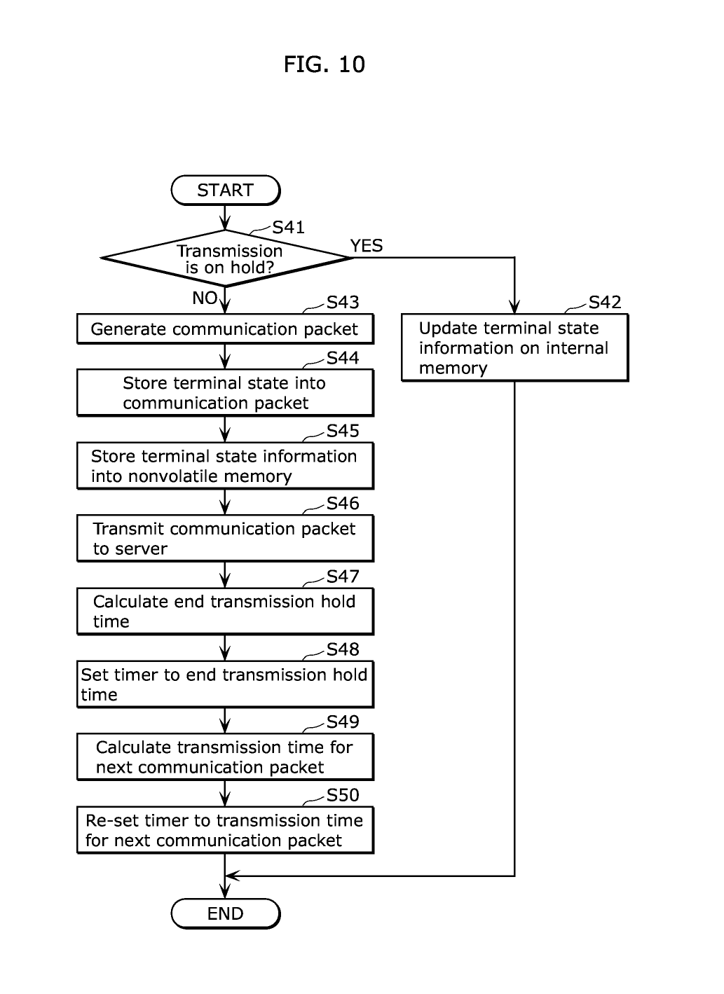

FIG. 10 is a flowchart illustrating a packet transmission process upon change of the terminal state of the network terminal 500 according to the present embodiment.

First, if the tuner 120 successfully selects a channel (i.e., if the terminal state is changed), it is determined whether the transmission hold flag 572 is enabled (step S41). It should be noted that since the transmission hold flag 572 is enabled during the hold time period, it can be expressed that it is determined in the determination whether transmission is on hold.

In step S41, if the microcomputer 170 determines that the transmission hold flag 572 is enabled (YES in step S41), the microcomputer 170 stores the currently viewed channel as the terminal state 571 (step S42). Thereafter, the processing ends.

On the other hand, in step S41, if the microcomputer 170 determines that the transmission hold flag 572 is not enabled (NO in step S41), the microcomputer 170 generates a communication packet (step S43).

Next, the microcomputer 170 stores the currently viewed channel into the terminal state information 197 of the communication packet 190 (step S44).

Next, the microcomputer 170 stores the currently viewed channel as the terminal state 565 into the nonvolatile memory 160 (step S45).

Next, the microcomputer 170 transmits the communication packet to the server 300 (step S46).

Next, the microcomputer 170 acquires the transmission hold time 564 from the nonvolatile memory 160, and adds the transmission hold time to the current time, thereby calculating the end time of the transmission hold time (step S47).

Next, the microcomputer 170 sets the timer 130 to the end time of the transmission hold time so as to receive an interrupt for ending the transmission hold when the end transmission hold time arrives (step S48).

Next, similarly to the process of step S13, the microcomputer 170 calculates a transmission time for the next communication packet (step S49).

Next, the microcomputer 170 re-sets the timer 130 to the transmission time for the next communication packet so as to receive an interrupt for packet transmission request when the transmission time calculated in step S49 arrives (step S50). At the end of step S49, the transmission time in step S14 is loaded into the timer 130 (FIG. 4) in the embodiment 1. Thus, the process of step S50 can also be expressed as the microcomputer 170 re-setting the timer 130 to the transmission time in step S50 and thereby correcting the transmission time.

Thereafter, the network terminal 500 ends the packet transmission process which is performed upon change of terminal state.

[2-2-2. Packet Transmission Process upon Release of Network Terminal from Holding Transmission]

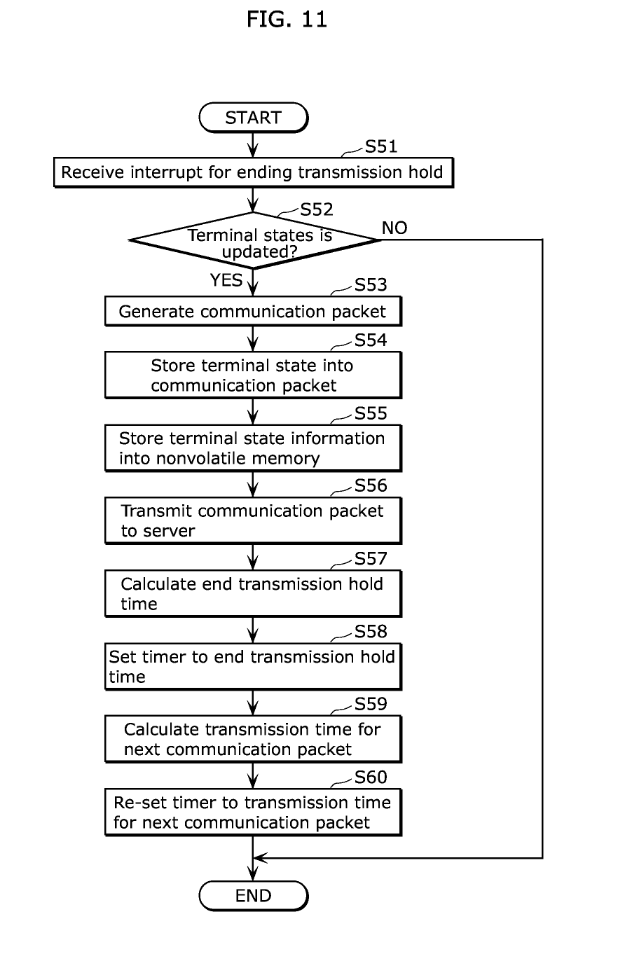

FIG. 11 is a flowchart illustrating a packet transmission process performed upon release of the network terminal 500 according to the present embodiment from the transmission hold time.

First, the microcomputer 170 receives an interrupt for ending the transmission hold from the timer 130 (step S51).

Next, the microcomputer 170 compares the terminal state 565 stored in the nonvolatile memory 160 and the terminal state 571 stored in the internal memory to check if the terminal states before and after the hold time period are different (step S52).

In step S52, if the terminal states are identical (NO in step S52), the processing by the network terminal 500 ends. On the other hand, in step S52, if the terminal states are different (YES in step S52), the microcomputer 170 generates a communication packet (step S53).

Thereafter, similarly to steps S44 to S50, processing of steps S54 to S60 is performed.

This is the end of the packet transmission process upon release from the transmission hold time.

According to the above processing, the network terminal 500 transmits an information packet immediately after the terminal state of the network terminal 500 is changed, and then enters the hold time period. If a terminal state of the network terminal 500 is changed during the hold time period, the network terminal 500 transmits after the hold time period an information packet which includes information indicative of the terminal state change.

[2-2-3. Sequence between Network Terminal and Server]

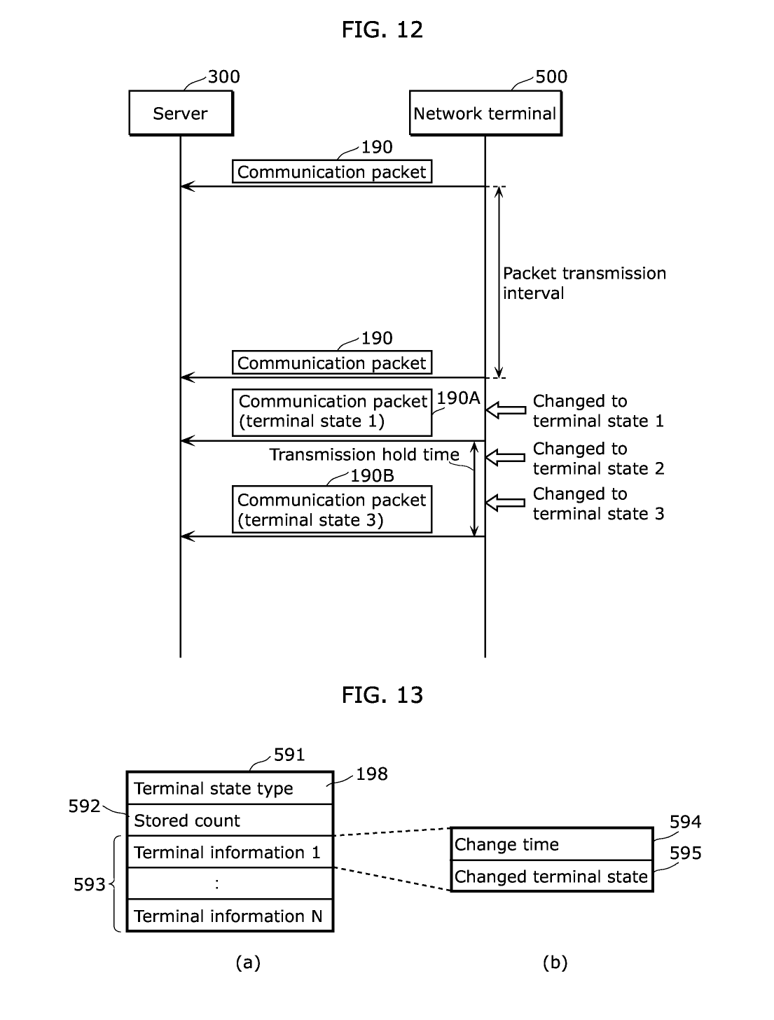

FIG. 12 is a sequence diagram showing communications between the network terminal 500 and the server 300 according to the present embodiment. In FIG. 12, transmission timings for communication packets which are exchanged between the network terminal 500 and the server 300 are shown. Typically, the network terminal 500 periodically transmits the communication packet 190 in the transmission interval 163 stored in the nonvolatile memory 160. Also, if the terminal state is changed, the network terminal 500 immediately transmits the communication packet 190A having stored therein the terminal state. The network terminal 500 then enters the transmission hold time 564 immediately after the network terminal 500 has transmitted the communication packet 190A. If the terminal state is changed during the transmission hold time 564, rather than transmitting the communication packet during the transmission hold time 564, after the transmission hold time 564 has elapsed, the network terminal 500 transmits a communication packet 190B having stored therein the terminal state at a moment when the transmission hold time 564 has elapsed.

If a plurality of the transmission hold time periods overlaps, putting transmission of a communication packet on hold continuously for a time longer than the transmission interval of a communication packet, the network terminal 500 transmits a communication packet or an information packet before the transmission interval is exceeded.

It should be noted that a history of terminal state change during the transmission hold time 564 may be included in the communication packet 190B.

While the description has been given where the packet transmission process of steps S53 to S56 is performed if the terminal states of the network terminal 500 before and after the hold time period are different in step S52 of FIG. 11, the packet transmission process of steps S53 to S56 may be preformed even if the terminal states of the network terminal 500 before and after the hold time period are identical. Specifically, according to the above description, if a terminal state 1 and a terminal state 3 are identical, the network terminal 500 does not perform the packet transmission process after the terminal state is changed from the terminal state 1 to the terminal state 3. However, the network terminal 500 may perform a packet transmission process for transmitting a packet which includes, as a history, a terminal state 2 and the terminal state 3 after the terminal state is changed to the terminal state 3.

[2-2-4. Transmission of History of Terminal State Change]

It should be noted that in step S42 of FIG. 10, a history of terminal state change may be stored, instead of storing the current terminal state. In the case of storing the history of terminal state change, the history of terminal state change may be stored in the communication packet in step S55 of FIG. 11, instead of storing the current terminal state. In other words, in FIG. 12, rather than storing only the terminal state 3, the terminal state 2 and the terminal state 3 which are a history of terminal state change during the transmission hold time 564 may be stored in the communication packet 190B to be transmitted after the transmission hold time 564 has elapsed. Hereinafter, a structure in which the history of terminal state change is stored in the communication packet will be described, with reference to FIG. 13.

FIG. 13 is a conceptual diagram showing a structure of the terminal state information 591 according to the present embodiment. FIG. 13 shows a structure of terminal state information 591 storing the history of terminal state change in the communication packet 190.

The terminal state information 591 includes a terminal state type 198, a stored count 592, and one or more pieces of terminal information 593. The stored count 592 is the number of pieces of the terminal information 593. The terminal information 593 includes a change time 594 and a changed terminal state 595. The change time 594 is a time at which the terminal state is changed.

The server 300 receives a communication packet which includes the terminal state information 591 to check a channel selected at the network terminal 500 during channel zapping. Using this information, the server 300 can make information, to be transmitted later to the network terminal 500, more appropriate. For example, channels not selected by the network terminal 500 during the zapping are expected to be unlikely to be viewed. Thus, reduction is possible in a frequency at which advertisement associated with these channels is transmitted to the network terminal 500.

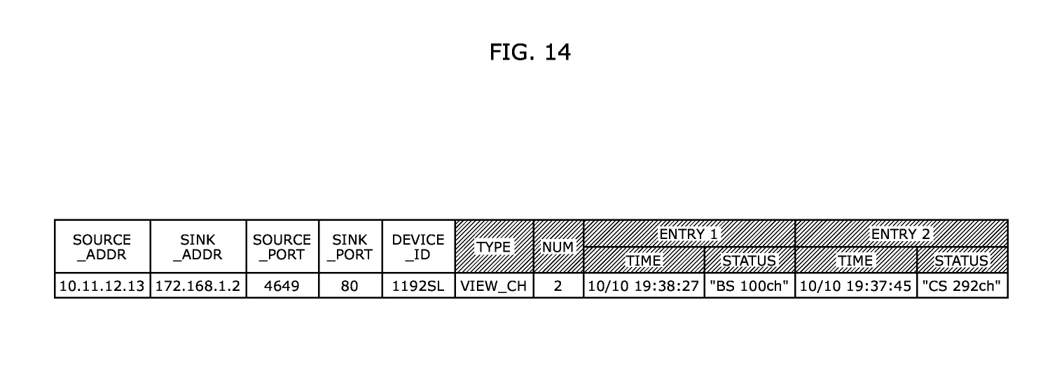

FIG. 14 is a diagram of a packet format of the communication packet 190 according to the present embodiment. The communication packet 190 includes required fields and extension fields. The cross-hatched portions correspond to the extension fields.

The required fields include a SOURCE_ADDR field, a SINK_ADDR field, a SOURCE_PORT field, a SINK_PORT field, and a DEVICE_{'}ID field.

An IP address of the network terminal 500 and a transmitting port number are stored in the SOURCE_ADDR field and the SOURCE_PORT field, respectively.

An IP address of the server 300 and a listen port number are stored in the SINK_ADDR field and the SINK_PORT field, respectively.

ID information allowing the server 300 to uniquely identify the network terminal 500 is stored in the DEVICE_ID field.

The extension fields include a TYPE field, a NUM field, and one or more ENTRY fields. A type of a terminal state is stored in the TYPE field of the ENTRY field. In the example of FIG. 14, the terminal state stored in the ENTRY field is VIEW_CH (viewing channel). The number of ENTRY fields is stored in the NUM field. In the example of FIG. 14, the number of ENTRY fields is 2. The ENTRY field further includes a TIME field and a STATUS field. A change time at which the terminal state is changed is stored in the TIME field, and a value of the terminal state is stored in the STATUS field. If a plurality of terminal state types is to be transmitted, a set of the TYPE field, the NUM field, and two or more ENTRY fields is repeated in the communication packet 190. While the order of terminal states stored in the ENTRY fields is not particularly defined, the example of FIG. 14 shows that a most recent terminal state is stored in the leading ENTRY1 field. In doing so, there is an advantageous effect that the current terminal state can be acquired by the server 300 referring only ENTRY1 field, in no need for the history of terminal state change.

[2-3. Summary]

As described above, in the present embodiment, the network terminal 500 periodically performs the packet transmission process to maintain the NAT table, and once the terminal state is changed by selection of channel, the network terminal 500 immediately performs the process of transmitting a packet which includes the terminal state. Also, the transmission hold time 564 is provided during which the packet transmission process is not performed even if the terminal state is changed again immediately after performing the above process.

This allows the server 300 to be notified of a new terminal state in real time, reducing a transmission load on the sever 300, even if the terminal state is highly frequently changed by zapping or the like. Thus, the network terminal 500 is likely to obtain content in accordance with the terminal state, from the server 300.

As described above, according to the network terminal of the present embodiment, the network terminal can transmit a change in terminal state of the network terminal during the hold time period in a communication packet (information packet) after the hold time period. This has an advantageous effect of reducing a number of transmissions of communication packets, in particular, when the terminal state of the network terminal is changed a large number of times in a short time. Thus, the network terminal can further reduce the amount of communications.

Moreover, the network terminal can transmit the history of terminal state change of the network terminal during the hold time period in a communication packet (information packet) after the hold time period. In this way, the device with which the network terminal communicates can acquire information on the terminal state change in more detail.

Moreover, the network terminal does not transmit a communication packet (an information packet) after the hold time period. Thus, the network terminal can further reduce the amount of communications.

Moreover, the device with which the network terminal communicates can initiatively specify the hold time for the network terminal, thereby further reducing the amount of communication packets over a network.

### Embodiment 3

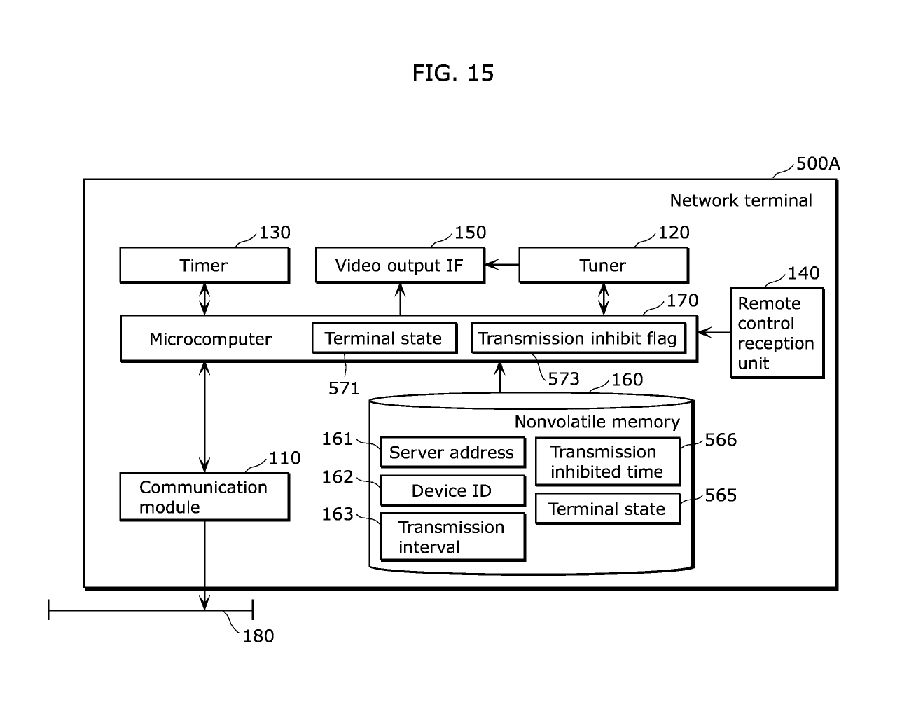

Hereinafter, an embodiment 3 will be described, with reference to FIGS. 15 to 18. The network terminal according to the present embodiment can reduce an amount of communications when the terminal state of the network terminal is frequently changed by employing a transmission inhibited time period. It should be noted that the same reference signs will be used to refer to the same components as those according to the embodiment 1 or 2, and detailed description may be omitted.

[3-1. Configuration]

[3-1-1. Network Connection Configuration]

A network (not shown) which includes a network terminal 500A according to the present embodiment is as with the embodiment 2 except that the embodiment 2 includes the network terminal 500A instead of the network terminal 500.

[3-1-2. Network Connection Configuration]

FIG. 15 is a block diagram of a configuration of the network terminal 500A according to the present embodiment. The network terminal 500A includes components similar to those of the network terminal 100 and, additionally, stores a transmission inhibited time 566 and a terminal state 565 in a nonvolatile memory 160.

The transmission inhibited time 566 is a time (an inhibited time period) during which transmission of a subsequent communication packet is inhibited upon change of the terminal state of the network terminal 500A. In other words, immediately after the terminal state of the network terminal 500A is changed, at which time another communication packet is not transmitted because it is during the inhibited time. Suppose that a user is switching channels one after another looking for a program desired by the user (=during channel zapping), if a communication packet is transmitted each time channels are switched, the transmission processing by the network terminal 500A increases, causing a heavier load on the network terminal 500A. Furthermore, the Internet 200 and the server 300 are also flooded with a large number of communication packets and loads are applied thereto. Hence, the transmission inhibited time 566 can reduce the load even if the terminal state is highly frequently changed. It is assumed that the transmission inhibited time 566 is shorter than the time period for which the router 400 maintains the NAT table. It should be noted that the transmission inhibited time 566 may be a value previously set to the network terminal 500A or a value received from the server 300.

The terminal state 565 indicates information such as channels previously viewed at the network terminal 500A. The terminal state 565 is created, updated, or deleted by the microcomputer 170, according to need.

The microcomputer 170 includes an internal memory. The microcomputer 170 stores a terminal state 571 and a transmission inhibit flag 573 in the internal memory, according to need. The terminal state 571 is information such as a channel currently viewed at the network terminal 500A. The transmission inhibit flag 573 is a flag which is enabled when the microcomputer 170 is during the inhibited time period.

[3-2. Operation]

Operations of the network terminal 500A and the server 300 configured as described above are described below. The network terminal 100 periodically performs a communication packet transmission process, and if the terminal state is changed, the network terminal 500A performs the communication packet transmission process. The communication packet transmission process periodically performed by the network terminal 500A is similar to that described in the embodiment 1. On the other hand, the network terminal 500A performs a packet transmission process upon change of the terminal state by a method different from the process disclosed in the embodiment 1, in consideration of the transmission inhibited time. Furthermore, the network terminal 500A performs a packet transmission process after the end of the transmission inhibited time. Hereinafter, details of the operation will be described.

[3-2-1. Processing upon Change of Terminal State of Network Terminal]

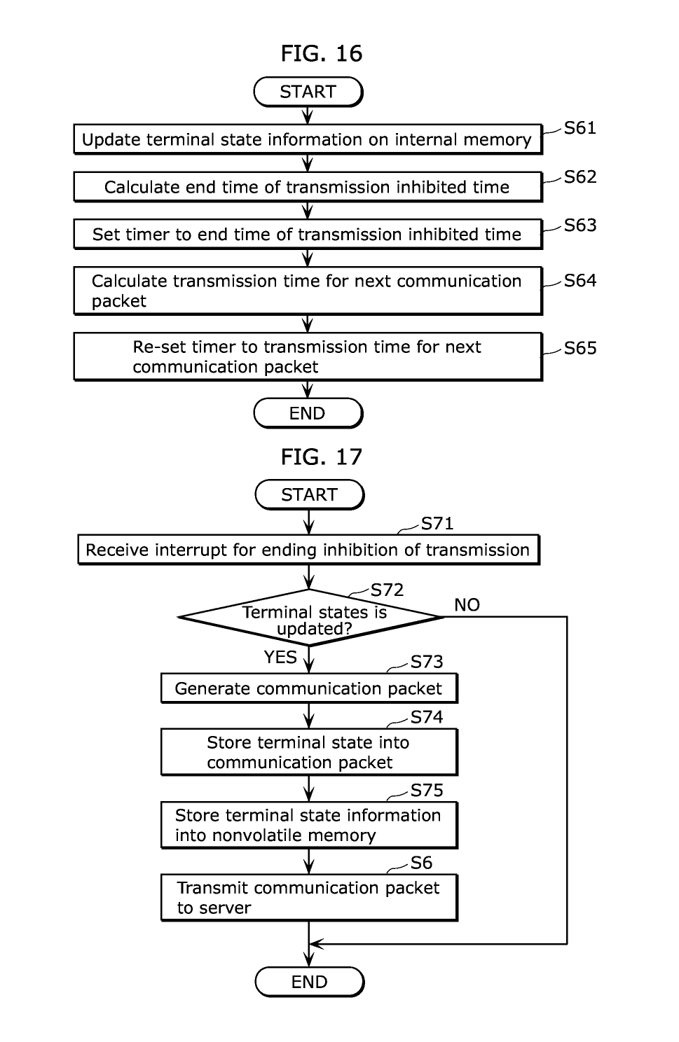

FIG. 16 is a flowchart illustrating a packet transmission process upon change of the terminal state of the network terminal 500A according to the present embodiment.

First, if the tuner 120 successfully selects a channel (i.e., if the terminal state is changed), the microcomputer 170 updates terminal state information on the internal memory (step S61).

Next, the microcomputer 170 calculates the end time of the transmission inhibited time period (step S62).

Next, the microcomputer 170 sets the timer 130 to the end time of the transmission inhibited time period (step S63).

Next, the microcomputer 170 calculates a transmission time for the next communication packet (step S64).

Next, the microcomputer 170 re-sets the timer 130 to the transmission time for the next communication packet so as to receive an interrupt for packet transmission request when the transmission time calculated in step S64 arrives (step S65). At the end of step S64, the transmission time in step S14 is loaded into the timer 130. Thus, the process of step S65 can also be expressed as the microcomputer 170 re-setting the timer 130 to the transmission time in step S65 and thereby correcting the transmission time.

Thereafter, the processing ends.

[3-2-2. Packet Transmission Process upon Unblocking of Transmission Performed by Network Terminal]

FIG. 17 is a flowchart illustrating a packet transmission process upon unblocking of packet transmission performed by the network terminal 500A according to the present embodiment.

First, the microcomputer 170 receives from the timer 130 an interrupt for ending the inhibition of transmission (step S71).

Next, the microcomputer 170 compares the terminal state 565 stored in the nonvolatile memory 160 and the terminal state 571 stored in the internal memory to check if the terminal states before and after the inhibited time period are different (step S72).

In step S72, if the terminal states are identical (NO in step S72), the processing by the network terminal 500A ends. On the other hand, in step S72, if the terminal states are different (YES in step S72), the microcomputer 170 generates a communication packet (information packet) (step S73).

Thereafter, similarly to steps S44 to S46, processing of steps S74 to S76 is performed.

This is the end of the packet transmission process upon release from the transmission hold time.

According to the above processing, the network terminal 500A transmits an information packet which includes information indicative of the state change after the inhibited time has elapsed, rather than transmitting the information packet immediately after the state change of the network terminal 500A.

[3-2-3. Sequence between Network Terminal and Server]

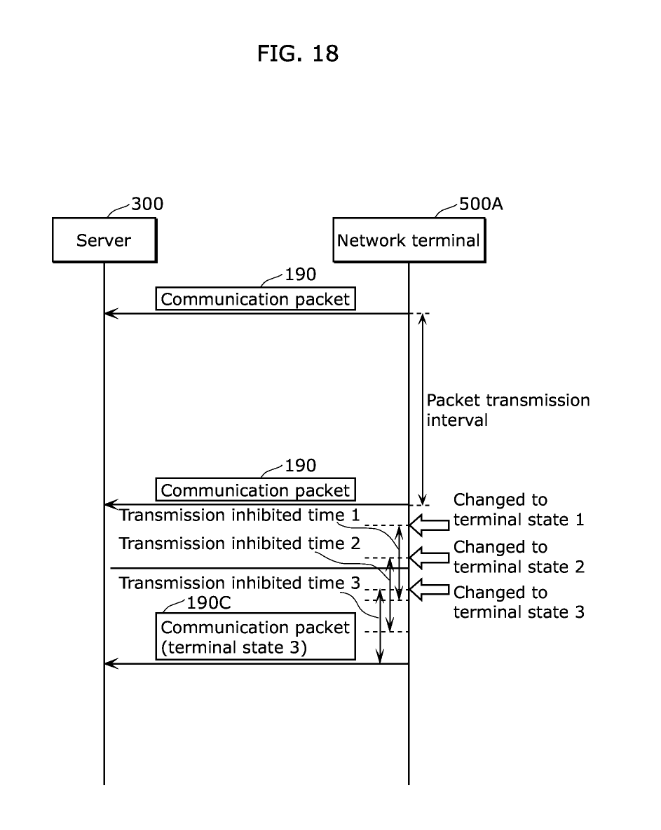

FIG. 18 is a sequence diagram showing communications between the network terminal 500A and the server 300 according to the present embodiment. In FIG. 18, transmission timings for communication packets which are exchanged between the network terminal 500A and the server 300 are shown. Typically, the network terminal 500A periodically transmits the communication packet 190 in the transmission interval 163 stored in the nonvolatile memory 160. Also, if the terminal state is changed, the network terminal 500A initiates the transmission inhibited time 566. If the terminal state is changed again during the transmission inhibited time, at which point the network terminal 500A initiates a new transmission inhibited time 566. Then, after the transmission inhibited time 566 has elapsed, the network terminal 500A then transmits the communication packet 190C (information packet) having stored therein the terminal state at a moment the transmission inhibited time 566 has elapsed.

If a plurality of the inhibited time periods overlaps, inhibiting transmission of a communication packet continuously for a time longer than the transmission interval of a communication packet, the network terminal 500A transmits a communication packet or an information packet before the transmission interval is exceeded.

It should be noted that a history of terminal state change during the transmission inhibited time 566 may be included in the communication packet 190C.

While the description has been given where the packet transmission process of steps S73 to S76 is performed if the terminal state of the network terminal 500A is updated during the inhibited time period in step S72, the packet transmission process of steps S73 to S76 may be preformed even if the terminal state of the network terminal 500A is not updated during the inhibited time period.

[3-3. Summary]

As described above, in the present embodiment, the network terminal 500A periodically performs the packet transmission process to maintain the NAT table, and if the terminal state is changed by selection of channel, the network terminal 500A performs the process of transmitting a packet which includes the terminal state after the transmission inhibited time period.

This allows the server 300 to be notified of a new terminal state in real time, reducing a transmission load on the sever 300, even if the terminal state is highly frequently changed by zapping or the like. Thus, the network terminal 500A is likely to obtain content in accordance with the terminal state, from the server 300.

As described above, according to the network terminal of the present embodiment, the network terminal can transmit a change in terminal state of the network terminal during the inhibited time period in a communication packet (information packet) after the inhibited time period. This has an advantageous effect of reducing a number of transmissions of communication packets, in particular, when the terminal state of the network terminal is changed a large number of times in a short time. Besides, the communication packet (information packet) is not transmitted immediately after the terminal state is changed. Consequently, this has more advantageous effect of reducing a number of transmissions of communication packets. Thus, the network terminal can further reduce the amount of communications.

Moreover, the network terminal can transmit the history of terminal state change of the network terminal during the inhibited time period in a communication packet (information packet) after the inhibited time period. In this way, the device with which the network terminal communicates can acquire information on the terminal state change in more detail.

Moreover, the network terminal does not transmit a communication packet (an information packet) after the inhibited time period if the terminal state of the network terminal after the inhibited time period is unchanged from the terminal state of the network terminal before the inhibited time period. Thus, the network terminal can further reduce the amount of communications.

Moreover, the device with which the network terminal communicates can initiatively specify the inhibited time for the network terminal, thereby further reducing the amount of communication packets over the network.

### Other Embodiment

As described above, the embodiments 1 to 3 has been described as illustration of implementation of the present disclosure. However, the present disclosure is not limited thereto and is applicable to embodiments to which modifications, permutations, additions, and omissions are made in the scope of the appended claims and the equivalents thereof. Moreover, the components described with reference to the above embodiments 1, 2, and 3 may be combined into a new embodiment.

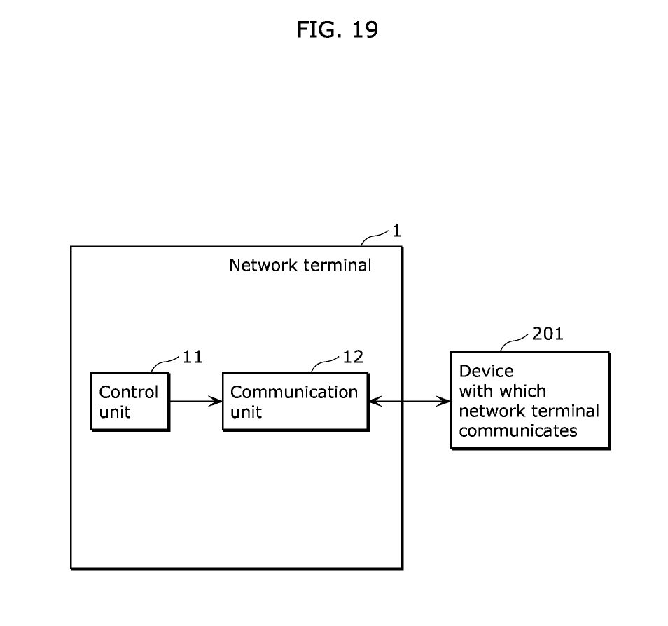

Essential components of the network terminal according to the embodiments 1 to 3 will be described. FIG. 19 is a block diagram of another configuration (a network terminal 1) of the network terminal according to the embodiments 1 to 3.

As shown in FIG. 19, the network terminal 1 includes a control unit 11 and a communication unit 12. The network terminal 1 is connected to a device 201 with which the network terminal 1 communicates.

By controlling the communication unit 12 the control unit 11 causes the communication unit 12 to transmit a communication packet for maintaining a communication path to the device 201 at transmission timings at predetermined intervals. Moreover, by controlling the communication unit 12 the control unit 11 causes the communication unit 12 to transmit, if the terminal state of the network terminal 1 is changed, an information packet which is a communication packet that includes terminal state information indicative of the terminal state of the network terminal 1 to the device 201 through the communication path even at a time different from the transmission timing.

The communication unit 12 communicates with the device 201 with which the network terminal 1 communicates through the communication path.

According to the network terminal 1, the network terminal periodically transmits (periodic transmission) a communication packet that is capable of maintaining a communication path, and also transmits, if the terminal state of the network terminal is changed, an information packet that is capable of maintaining the communication path and also notifying the terminal state of the network terminal to the device with which the network terminal communicates. If the communication packet or the information packet passes through the communication path, the communication path is maintained for a predetermined time period thereafter. By setting the predetermined time period so that the next communication packet or the information packet can pass through the communication path within the predetermined time period, the communication path is maintained over an extended time period longer than the predetermined time period. If there is no change in terminal state of the network terminal, the communication path is maintained by a communication packet that is periodically transmitted. On the other hand, if the terminal state of the network terminal is changed, the communication path is maintained and the change in terminal state of the network terminal is notified to the device with which the network terminal communicates, using the information packet that is capable of maintaining the communication path in addition to notifying the terminal state of the network terminal. Since immediately after the terminal state of the network terminal is changed, the network terminal notifies the change in terminal state of the network terminal to the device with which the network terminal communicates, the network terminal can acquire, from the device with which the network terminal communicates, data in accordance with the terminal state of the network terminal.

Thus, hereinafter, other embodiments will be described collectively.

In the embodiments 1 to 3, the currently viewed channel has been described by way of example of the terminal state. However, the terminal state is not limited thereto. Use of a result of person detection or person identification using an image captured by a camera connected to the network terminal, as the terminal state, facilitates acquisition, from the server, of content that is best suited for a user who is using the network terminal. Furthermore, for example, a sound obtained by a microphone, a measurement value obtained by a temperature sensor, or positional information obtained by a global positioning system (GPS) may be used as the terminal state. If it is determined from such an input value that a network terminal is being used by a user, the server sends out content to the terminal, thereby improving the chances that content is utilized.

Moreover, the description has been given in the embodiments 1, 2, and 3 that the network terminal 100, 500, and 500A, respectively, transmit a predetermined terminal state. However, the terminal state type to be transmitted may be specified by the server 300 to the network terminal. This allows the server 300 to efficiently collect a terminal state that has a type required for transmission conditions of content. Moreover, the network terminal may set the terminal state type to send. This can protect privacy of a user who uses the network terminal.

Moreover, the description has been given in the embodiment 2 that the end time of the transmission hold time is calculated using the transmission hold time 564 stored in the network terminal 500. The transmission hold time may be specified by the server 300 to the network terminal 500 within a range capable of maintaining the NAT table. This can reduce transmission frequency during a time in which the access to the server 300 is flooded.

Moreover, the description has been given in the embodiment 3 that the end time of the transmission inhibited time is calculated using the transmission inhibited time 566 stored in the network terminal 500A. The transmission inhibited time may be specified by the server 300 to the network terminal 500 within a range capable of maintaining the NAT table. This can reduce transmission frequency during a time in which the access to the server 300 is flooded.

Moreover, the description has been given in the embodiment 2 that the end time of the transmission hold time is calculated using one type of the transmission hold time 564. The transmission hold time, however, may be determined for each network terminal 500. This allows the network terminal 500 that has a large number of viewable channels to use a longer transmission hold time because channel zapping takes longer in such a network terminal. Alternatively, the transmission hold time may be determined for each terminal state. This enables a devise for reducing unintended transmission of communication packet by allocating a longer transmission hold time to a result of input to a microphone that is likely to induce noise.

Moreover, the description has been given in the embodiment 3 that the end time of the transmission inhibited time is calculated using one type of the transmission inhibited time 566. The transmission inhibited time, however, may be determined for each network terminal 500. This allows the network terminal 500 that has a large number of viewable channels to use a longer transmission hold time because channel zapping takes longer in such a network terminal. Alternatively, the transmission inhibited time may be determined for each terminal state. This enables a devise for reducing unintended transmission of communication packet by allocating a longer transmission inhibited time to a result of input to a microphone that is likely to induce noise.

Moreover, the description has been given in the embodiments 1, 2, and 3 that the network terminal 100, 500, and 500A, respectively, notify the terminal state to the server 300 in real time by one-way communications. The server 300 may transmit a terminal state acknowledgement packet to the network terminal to indicate receipt of the terminal state. Furthermore, if the network terminal fails to receive a terminal state acknowledgement packet for the communication packet 190A, 190B, or 190C stored in the terminal state, the network terminal may transmit the communication packet 190 having the current terminal state stored therein at the transmission of the next communication packet 190. This allows the notification of the current terminal state to the server 300 even if a time period during which the server 300 cannot update the terminal state stored in the server 300 for each network terminal occurs due to the server 300 failing to successfully receive the communication packet 190 that has the terminal state stored therein because of anomalies in the Internet 200 or a load on the server 300.

Moreover, the description has been given in the embodiments 1, 2, and 3 that the server 300 is notified of the terminal states of the network terminal 100, 500, and 500A, respectively, by transmission of the communication packet 190, 190A, 190B, or 190C, and the server 300 sends out content suited for the respective terminal states. When the server 300 sends out the content to the network terminal, the terminal state may be attached with information on a terminal state in the course of sending out the content, and if the attached terminal state is different from the terminal state of the network terminal, the network terminal may transmit a communication packet having the current terminal state stored therein to the server 300. This overcomes mismatch between the terminal states which are stored in the network terminal and the server 300.

Moreover, the description has been given in the embodiments 1, 2, and 3, assuming the network terminal 100, 500, and 500A, respectively, which include the tuner 120. Examples of the network terminal 100 include digital TVs and digital video recorders. The network terminal 100 may also be a network terminal which is connected to a camera or various sensors, instead of the tuner 120. For example, suppose that a network-enabled signage display is connected to a camera and transmits, as a terminal state, a feature of a person recognized by the camera to the server 300. The server 300 transmits adult-oriented signage content if the person is an adult, and transmits child-oriented signage content if the person is a child, thereby enhancing effects of signage. Moreover, for a smartphone with GPS, the smartphone can transmit positional information as the terminal state to the server 300 for transmission of content suitable for the position from the server 300.

As the above, the embodiment has been described by way of example of the technology of the present disclosure. To this extent, the accompanying drawings and detailed description are provided.

Thus, the components set forth in the accompanying drawings and detailed description includes not only components essential to solve the problems but also components unnecessary to solve the problems for illustrating the above embodiments. Thus, those unnecessary components should not be acknowledged essential due to the mere fact that the unnecessary components are described in the accompanying drawings and the detailed description.

The above embodiments illustrate the technology of the present disclosure, and thus various modifications, permutations, additions and omissions are possible in the scope of the appended claims and the equivalents thereof.

Although only some exemplary embodiments of the present disclosure have been described in detail above, those skilled in the art will readily appreciate that many modifications are possible in the exemplary embodiments without materially departing from the novel teachings and advantages of the present disclosure. Accordingly, all such modifications are intended to be included within the scope of appended Claims and the equivalents.

### INDUSTRIAL APPLICABILITY

The non-limiting embodiments according to the present disclosure are applicable to network terminals which can acquire data in accordance with the terminal state from a server on the Internet, and, specifically, applicable to digital TVs, HDD recorders, smartphones, signage displays, for example.

1. A network terminal comprising:
a communication unit configured to communicate with a device with which the network terminal communicates through a communication path; and
a control unit configured to cause the communication unit, by controlling the communication unit, to transmit to the device a communication packet for maintaining the communication path at a transmission timing in every predetermined interval,
wherein by controlling the communication unit, the control unit is further configured to cause the communication unit to
transmit an information packet to the device through the communication path even at a time different from the transmission timing, if a terminal state of the network terminal is changed, and
determine a new transmission timing for the communication packet in each predetermined interval, starting from a moment at which the communication unit has transmitted the information packet, the information packet being a communication packet obtained by storing terminal state information indicative of the terminal state into the communication packet for maintaining the communication path.

2. The network terminal according to claim 1,
wherein by controlling the communication unit, the control unit is configured to cause the communication unit to transmit the information packet which includes the terminal state information indicative of the terminal state during a hold time period if the terminal state is changed during the hold time period until a predetermined hold time elapses since the communication unit has transmitted the information packet, after the hold time period.

3. The network terminal according to claim 2,
wherein by controlling the communication unit, the control unit is configured to cause the communication unit to transmit, after the hold time period, the information packet which includes the terminal state information indicative of a history of the terminal state during the hold time period.

4. The network terminal according to claim 2,
wherein the control unit is configured to inhibit the communication unit from transmitting the information packet if the terminal state after the hold time period is unchanged from the terminal state before the hold time period.

5. The network terminal according to claim 2,
wherein the control unit is configured to control the communication unit, using as the hold time a hold time that is specified by the device.

6. The network terminal according to claim 1,
wherein the control unit is configured to inhibit the communication unit from transmitting the information packet during an inhibited time period until a predetermined inhibited time elapses since the terminal state is changed, and, by controlling the communication unit, cause the communication unit to transmit, after the inhibited time period, the information packet which includes the terminal state information indicative of the terminal state during the inhibited time period.

7. The network terminal according to claim 6,
wherein by controlling the communication unit, the control unit is configured to cause the communication unit to transmit, after the inhibited time period, the information packet which includes the terminal state information indicative of a history of the terminal state during the inhibited time period.

8. The network terminal according to claim 6,
wherein the control unit is configured to inhibit the communication unit from transmitting the information packet if the terminal state after the inhibited time period is unchanged from the terminal state before the inhibited time period.

9. The network terminal according to claim 6,
wherein the control unit is configured to control the communication unit, using as the inhibited time an inhibited time that is specified by the device.

10. The network terminal according to claim 1, further comprising
a broadcast receipt unit configured to receive broadcast of a broadcast channel,
wherein the communication unit is configured to transmit, as the terminal state information, the information packet which includes information indicative of the broadcast channel received by the broadcast receipt unit.

11. The network terminal according to claim 1,
wherein the communication unit is further configured to receive advertising content in accordance with the terminal state, transmitted by the device,
the network terminal further comprising a display unit configured to display the advertising content.

12. The network terminal according to claim 11, further comprising
a positional information acquisition unit configured to acquire positional information of the network terminal,
wherein the communication unit is configured to transmit the information packet which includes the positional information as the terminal state information, and receive the advertising content in accordance with the positional information, transmitted by the device.

13. The network terminal according to claim 11, further comprising
a sensor for acquiring attribute information indicative of an attribute of a person near the network terminal or environmental information indicative of environment surrounding the network terminal,
wherein the communication unit is configured to transmit the information packet which includes at least one of the attribute information and the environmental information as the terminal state information.

14. The network terminal according to claim 1,
wherein a router having a network address translation (NAT) function is disposed on the communication path, and
the communication unit is configured to maintain a NAT table in the router by transmitting the communication packet or the information packet to the device through the router to maintain the communication path.

15. A communication method executed by a network terminal including a communication unit configured to communicate with a device with which the network terminal communicates through a communication path, the communication method comprising:
causing the communication unit, by controlling the communication unit, to transmit to the device a communication packet for maintaining the communication path at a transmission timing in every predetermined interval; and
by controlling the communication unit, causing the communication unit to
transmit an information packet to the device through the communication path even at a time different from the transmission timing, if a terminal state of the network terminal is changed, and
determine a new transmission timing for the communication packet in each predetermined interval, starting from a moment at which the communication unit has transmitted the information packet, the information packet being a communication packet obtained by storing terminal state information indicative of the terminal state into the communication packet for maintaining the communication path.

16. A computer-readable recording medium having stored therein a program for causing a computer to execute the communication method according to claim 15.

17. A communication system comprising:
the network terminal according to claim 1; and
a device with which the network terminal communicates.
